(19) United States
(12) Patent Application Publication
(10) Pub. No.: US 2017/0257614 A1
(43) Pub. Date: Sep. 7, 2017

(54) THREE-DIMENSIONAL AUTO-FOCUSING DISPLAY METHOD AND SYSTEM THEREOF

(71) Applicant: LIQUID3D SOLUTIONS LIMITED, Tsim Sha Tsui (HK)

(72) Inventor: JOHNNY PAUL ZHENG-HAO WANG, Pingzhen City (TW)

(21) Appl. No.: 15/143,570

(22) Filed: Apr. 30, 2016

(30) Foreign Application Priority Data
Mar. 4, 2016 (TW) 105106632

(51) Int. Cl. H04N 13/00; H04N 13/02; H04N 13/04

(52) U.S. Cl. CPC H04N 13/0033; H04N 13/0484; H04N 13/0203; H04N 13/0497; H04N 13/0022; H04N 2013/0074

(57) ABSTRACT

A 3D auto-focusing display method comprises executing an eye-tracking step on a 3D image to obtain focal point coordinates (x1, y1) of viewers of the image, mapping the focal point coordinates (x1, y1) of viewers to a coordinate location of a display to obtain display coordinates (x2, y2) for defining the coordinate location of the display corresponding to a depth diagram of the 3D image, determining a region where the image is located by using the display coordinates (x2, y2) as an input parameter and by use of the depth diagram of the image, determining whether the image is 3D stereoscopic images according to the region and executing a depth map step to revise the 3D image based on the image and a plurality of depth data of the region to reflect the display coordinates (x2, y2) as a focused image, and outputting the revised focused image to the display.

### BACKGROUND OF THE INVENTION

1. Field of the Invention

The present invention relates to an auto-focusing method, particularly with regard to a three-dimensional (3D) auto-focusing display method and an auto-focusing display system thereof.

2. The Related Arts

The basic technique of stereoscopic displays is practiced by presenting image deviation. Deviated images are respectively displayed in left eyes and right eyes of users, and then the two displayed two-dimensional (2D) deviated images are merged in user's brain to obtain 3D depth perception. There are many display technology ways to achieve display of stereoscopic 3D images, for example, use of polarized and shutter lenses, dual convex lens and barrier lens for naked-eye 3D images, and for example, use of dual displays such as headset products used for virtual reality.

It is well known that many people experience eye fatigue and discomfort when watching stereoscopic videos. There are a variety of factors causing such discomfort. In such an example, it is well known that the above mentioned discomfort includes, for example, physical discomfort caused by 3D glasses, including dizziness caused by head-mounted products due to waiting time of displaying video images relative to movement of user's head, and image blurred caused by cross-talk. Embodiments described above are all problems caused by and involved in lack of hardware display technology.

It is worth noticing that quality of a 3D stereoscopic content is also a main reason for eyestrain and eye fatigue when viewing 3D stereoscopic display. Generally, there are three ways to form stereoscopic 3D images. The stereoscopic 3D images can be natural captured by using a stereo camera system, or converted from 2D images. This means that two views of the original 2D image are generated from a mode of computer programs. Calculation of related characteristics of the 3D stereoscopic content causing viewer's discomfort is not so important. However, this is because of actual existence of reliable indicators to quantify the 3D stereoscopic content, such as vertical parallax and difference in color, contrast and brightness of the stereoscopic image perceived in user's eyes.

A key characteristic of the quality of the 3D stereoscopic content is accommodation-convergence conflict. Accommodation is defined as a focal plane of eyes, and convergence refers to a focal point of the eyes. In the nature, accommodation and convergence are simultaneously determined by a distance from viewer's eyes to images. Natural viewing causes simultaneous convergence and accommodation. When viewing images on a 3D stereoscopic display, accommodation refers to a physically displayed distance, and convergence refers to a perceived distance between virtual images on a screen. It has a virtual binocular depth and a display screen in front of or behind the perceived distance. When viewing 3D display, convergence and accommodation are separate and not equal. Therefore, eye fatigue problem is essentially caused by unnatural viewing resulted from viewing the 3D stereoscopic content on the display to cause unnatural viewing. Since human eyes are adapted to have a habit of unnatural viewing, an extent of the unnatural viewing, within a tolerable range, can be determined by images of the 3D stereoscopic content themselves.

An extent of separation of convergence and accommodation of a 3D stereoscopic content is determined by a horizontal parallax characteristic of the 3D stereoscopic content. It is worth noticing that there is a region or a separating range of convergent and accommodation within which it is generally acceptable for human eyes, and minimum eye fatigue and eyestrain may be present. The ideal horizontal parallax of the 3D stereoscopic content is in this region or range in order to avoid adverse viewing symptoms.

### SUMMARY OF THE INVENTION

According to drawbacks of the conventional technology, the present invention discloses a method and system for achieving an auto-focusing function when viewing images on a three-dimensional (3D) display. The auto-focusing display method and system are accomplished by using eye-tracking technology and depth diagram camera systems.

Another object of the three-dimensional (3D) auto-focusing display method and a system thereof disclosed in accordance with the present invention is to build a 3D system which can simulate natural viewing. Accordingly, the three-dimensional (3D) auto-focusing display method and a system thereof disclosed in accordance with the present invention do not need glasses or other assistive devices to view in order to increase convenience and expand applications for optimizing simulation of a natural viewing environment.

Simulation of nature viewing is further achieved through eye-tracking technology systems. For viewer's eyes, accommodation of a 3D display system refers to a fixed distance between viewer's eyes and the display when assuming that no relative movement exists between viewers and 3D images. A convergence point (or called as a focal point) of viewer's eyes is based on presenting of objects and scenes of the 3D content in any case. Hence, it is not fixed. Therefore, an auto-focusing display system is proposed in accordance with the present invention in order to assure a focal point of viewer's eyes matching displayed coordinates so that an ability of natural viewing can be better practiced.

According to the display and eye-tracking system described above, a three-dimensional auto-focusing display method in accordance with the present invention is provided to comprise integration of two systems. The method comprises a step of displaying images of 3D stereoscopic content at first wherein viewer's eyes are focused on a specific point in a physical space. Next, a step of executing an eye-tracking step is performed to obtain focal point coordinates (x1, y1) of viewers, and determine the focal point coordinates (x1, y1) of viewers by using an eye-tracking system. Then, a step of mapping the focal point coordinates (x1, y1) of viewers to display coordinates (x2, y2) is performed, and the display coordinates (x2, y2) are represented by pixel coordinates of a display. A step of executing a depth map step on the image in order to obtain a depth diagram corresponding to the image is then performed. The depth diagram can be obtained by using hardware components or by using depth structural algorithms to process 3D stereoscopic images. The display coordinates (x2, y2) relative to the image are used as input parameters of an image processing module of the three-dimensional (3D) stereoscopic display system. The image processing module determines in which region along coordinates the image is located by input of the display coordinates (x2, y2) and by use of the image depth diagram. The image depth diagram is an identifying factor of regions of the image. In other words, the depth diagram is a combination of segments of different regions. Each segment is defined as a set of pixels of the image, which has a same depth value or in a range of the same depth value. The image processing module uses a combination of images and depth data to correct 3D stereoscopic images, and to reflect the display coordinates (x2, y2) as focuses. Then, the image processing module outputs the corrected and focused image by forming a sub-pixel pattern (RGB patterns), and outputs the corrected and focused image to the display to form a sub-pixel pattern for convenient viewing.

According to the three-dimensional (3D) auto-focusing display method as mentioned above, the present invention further discloses a three-dimensional (3D) auto-focusing display system, and the disclosed three-dimensional (3D) auto-focusing display system can display stereoscopic contents and three-dimensional (3D) stereoscopic auto-focusing images characteristics without any need of glasses. The three-dimensional (3D) auto-focusing display system comprises a 3D auto-stereoscopic display module, a front viewer image capturing sensor module (or an eye-tracking camera) used for direct execution of eye-tracking function to obtain focal point coordinates (x1, y1) of viewers, and a rear viewer image capturing sensor module (or a stereoscopic depth camera) used for capturing stereoscopic images and/or capturing 2D images along with a depth diagram of an image. The system also comprises a plurality of image processing modules. The image processing modules are used for forming, gaining and outputting to display three-dimensional (3D) stereoscopic images. Three-dimensional (3D) stereoscopic images are formed by using 2D images and depth diagram information corresponding to the 2D images. Gain of three-dimensional (3D) stereoscopic images is processed by executing a number of image analyses and filtering algorithm on three-dimensional (3D) stereoscopic images, and by correcting three-dimensional (3D) stereoscopic images in use of image data and depth diagram data. Another image processing module uses a method of extrapolating to extrapolate the focal point coordinates (x1, y1) of viewers, and therefore executes auto-focusing and translates the focal point coordinates (x1, y1) of viewers into display coordinates (x2, y2) (or named as second coordinates) with respect to the display module. Then, segments of the image are confirmed in order to reflect the display coordinates (x2, y2), and used to form a suitable stereoscopic gained image in order to confirm the stereoscopic image being displayed is located on focuses. The last image processing module functions for inputting and gaining stereoscopic images, and then for executing RGB sub-pixel algorithm to output stereoscopic images to the display module.

### BRIEF DESCRIPTION OF THE DRAWINGS

FIG. 1 shows a schematic flow chart diagram of steps of a three-dimensional (3D) auto-focusing display method disclosed in accordance with the present invention;

FIG. 2 shows a schematic block diagram of a three-dimensional (3D) auto-focusing display system disclosed in accordance with the present invention;

FIG. 3 shows a schematic diagram of a three-dimensional (3D) stereoscopic image obtained from a display module when a rear viewer image capturing sensor module is a stereo camera in accordance with the present invention;

FIG. 4 shows a schematic diagram of a three-dimensional (3D) stereoscopic image obtained from the display module when the rear viewer image capturing sensor module is a time-of-flight camera in accordance with the present invention; and

FIGS. 5 to 9 show schematic diagrams of execution of the steps of the three-dimensional (3D) auto-focusing display method of FIG. 1 disclosed in accordance with the present invention.

### DETAILED DESCRIPTION OF PREFERRED EMBODIMENT

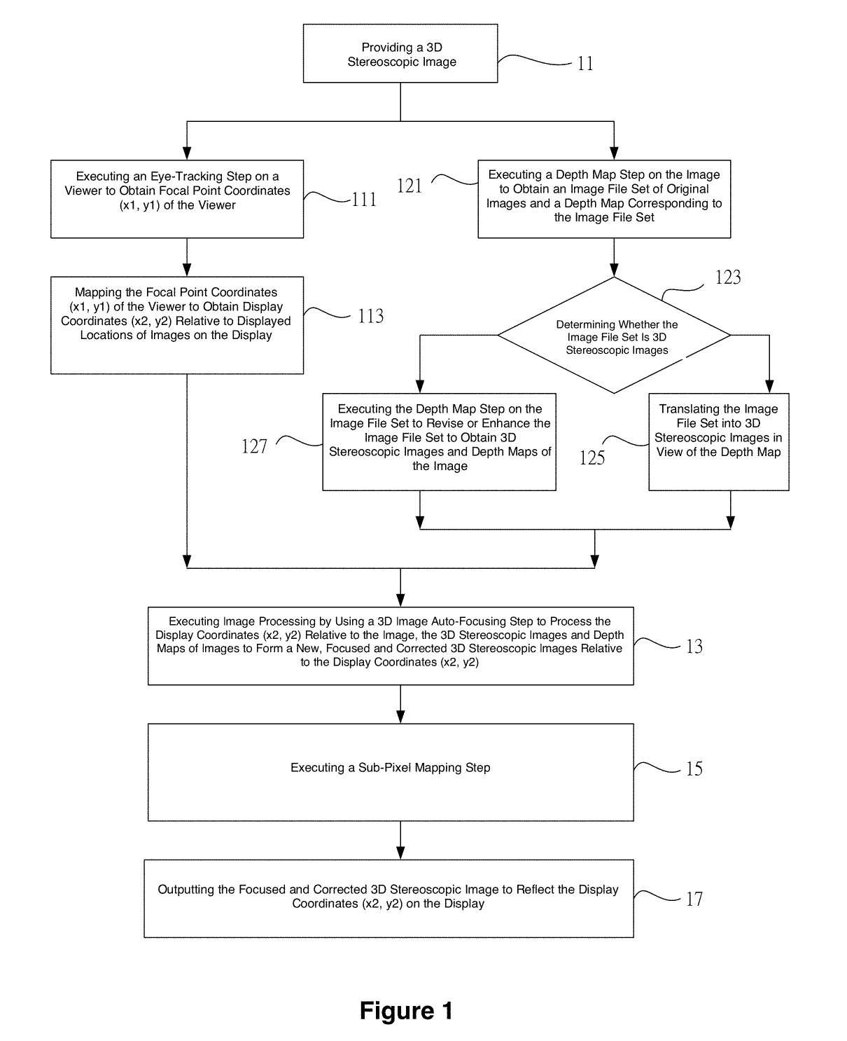

Referring to FIG. 1 at first, FIG. 1 shows a schematic flow chart diagram of steps of a three-dimensional (3D) auto-focusing display method disclosed in accordance with a preferred embodiment of the present invention. As shown in FIG. 1, in step 11, a step of providing a three-dimensional (3D) stereoscopic image is performed. The image is one of a landscape, portrait or physical substance goods. Next, in step 111, a step of executing an eye-tracking step on the image is performed while initiating or using a front viewer image capturing sensor module. The eye-tracking step is executed to obtain focal point coordinates (x1, y1) of viewers. In step 113, a step of mapping the focal point coordinates (x1, y1) of viewers to a coordinate location of a display is performed in order to obtain display coordinates (x2, y2) relative to displayed locations of images on the display. In addition, in step 121, a step of executing a depth map step on the image simultaneously during performing the step 111 in order to obtain an image file set of original images and a depth diagram corresponding to the image file set. Furthermore, in step 123, a step of determining whether the image file set is three-dimensional (3D) stereoscopic images is performed. If not, executing step 125, a step of translating the image file set into three-dimensional (3D) stereoscopic images in view of the depth diagram is performed. If so, executing step 127, a step of executing the depth map step on the image file set to revise or enhance the image file set so as to obtain three-dimensional (3D) stereoscopic images and depth diagrams of the image is performed.

Next, in step 13, a step of executing image processing is performed by using a three-dimensional (3D) image auto-focusing step to process the display coordinates (x2, y2) relative to the image, the three-dimensional (3D) stereoscopic images and depth maps of images so as to form a new, focused and corrected three-dimensional (3D) stereoscopic images relative to the display coordinates (x2, y2). In step 15, a step of executing a sub-pixel mapping step is performed to further focus and correct the three-dimensional (3D) stereoscopic images. Finally, in step 17, a step of outputting the focused and corrected three-dimensional (3D) stereoscopic image to reflect the display coordinates (x2, y2) on the display.

In more details, the three-dimensional auto-focusing display method in accordance with the present invention is provided to comprise integration of two systems. The method comprises a step of displaying images of 3D stereoscopic content, such as the step 11, at first wherein viewer's eyes are focused on a specific point in a physical space. Next, a step of executing an eye-tracking step, such as the step 111, is performed to obtain focal point coordinates (x1, y1) of viewers, and determine the focal point coordinates (x1, y1) of viewers by using an eye-tracking system. Then, a step of mapping the focal point coordinates (x1, y1) of viewers to display coordinates (x2, y2), such as the step 113, is performed, and the display coordinates (x2, y2) are represented by pixel coordinates of a display. A step of executing a depth map step on the image in order to obtain a depth diagram corresponding to the image, such as the step 121, is then performed. The depth diagram can be obtained by using hardware components or by using depth structural algorithms to process 3D stereoscopic images. The display coordinates (x2, y2) relative to the image are used as input parameters of an image processing module 25 of the three-dimensional (3D) stereoscopic display system 2 of the present invention. The image processing module 25 determines in which region along coordinates the image is located by input of the display coordinates (x2, y2) and by use of the image depth diagram. The image depth diagram is an identifying factor of regions of the image. In other words, the depth diagram is a combination of segments of different regions. Each segment is defined as a set of pixels of the image, which has a same depth value or in a range of the same depth value. The image processing module 25 uses a combination of images and depth data to correct 3D stereoscopic images, and to reflect the display coordinates (x2, y2) as focuses. Then, the image processing module 25 outputs the corrected and focused image by forming a sub-pixel pattern (RGB patterns), and outputs the corrected and focused image to the display to form a sub-pixel pattern for convenient viewing.

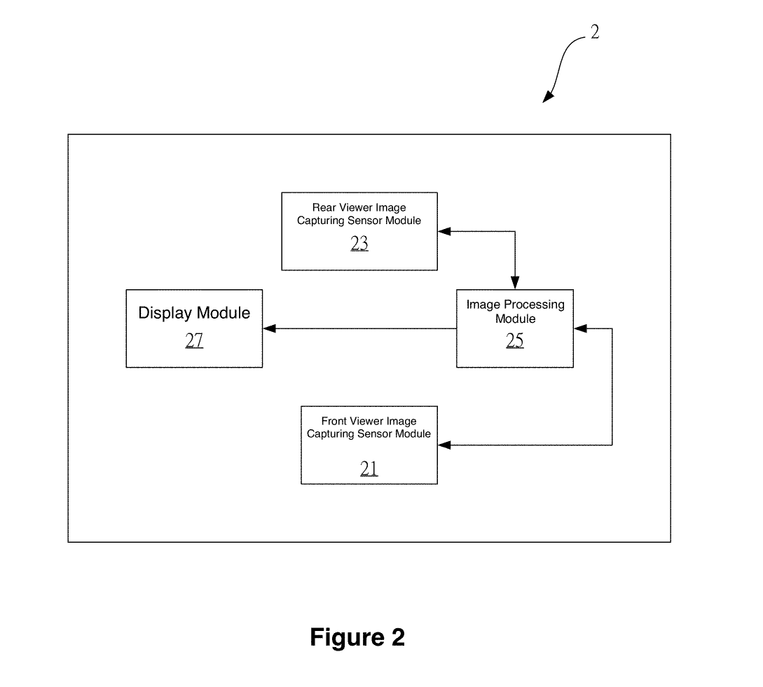

Next, referring to FIG. 2, FIG. 2 shows a schematic block diagram of a three-dimensional (3D) auto-focusing display system disclosed in accordance with a preferred embodiment of the present invention. In FIG. 2, the three-dimensional (3D) auto-focusing display system 2 comprises a front viewer image capturing sensor module 21, a rear viewer image capturing sensor module 23, an image processing module 25 and a display module 27. The image processing module 25 is respectively electrically connected to the front viewer image capturing sensor module 21, the rear viewer image capturing sensor module 23 and the display module 27. The front viewer image capturing sensor module 21 is used for performing the eye-tracking function on the image to obtain the focal point coordinates (x1, y1) of viewers of the locations of the image. In a preferred embodiment of the present invention, the front viewer image capturing sensor module 21 can be a camera module with an infrared (IR) sensor. The camera module is capable of locating focal points in the viewer's eyes when it is combined with image pupil detection processing. The front viewer image capturing sensor module 21 can also be a camera apparatus with sensors or a web camera apparatus with pupil detection function.

The rear viewer image capturing sensor module 23 is used for image capturing from the image and acts as a source of stereoscopic images in the present invention. In a preferred embodiment of the present invention, the rear viewer image capturing sensor module 23 can be a stereo camera module with a time-of-flight sensor. The camera module can be used to capture stereoscopic images by itself or to capture images relative to a depth diagram by using a flying sensor. Another example of the rear viewer image capturing sensor module 23 comprises a stereo camera apparatus without any time-of-flight sensor, and a two dimensional (2D) image sensor. The rear viewer image capturing sensor module 23 is not limited the above examples. The modules mentioned above can establish stereoscopic images and depth diagrams for output by using image processing of stereoscopic or 2D images. The rear viewer image capturing sensor module 23 can also be one of a time-of-flight camera apparatus, a stereoscopic camera apparatus, and a web camera apparatus with image depth generating function.

The image processing module 25 is used for executing an image processing step. The image processing step comprises identification of stereoscopic images and depth diagrams corresponding to the stereoscopic images, and establishing of an image data set, a stereoscopic image and a depth diagram corresponding to the stereoscopic image. The image processing module 25 is used for processing the focal point coordinates (x1, y1) of viewers, mapping the focal point coordinates (x1, y1) of viewers to display coordinates (x2, y2) relative to the display module 27, and executing auto-focusing gains and correction procedures to reflect the display coordinates (x2, y2) on the display module 27.

After processing of the image processing module 25, the focused and corrected three-dimensional (3D) stereoscopic images are able to reflect the display coordinates (x2, y2), and are transmitted to the display module 27 which can display three-dimensional (3D) stereoscopic images. The transmitted three-dimensional (3D) stereoscopic images are displayed for viewers having specific focusing with image sections.

The above disclosed three-dimensional (3D) auto-focusing display system 2 can display stereoscopic contents and three-dimensional (3D) stereoscopic auto-focusing images characteristics without any need of glasses. In details, the three-dimensional (3D) auto-focusing display system 2 comprises a 3D auto-stereoscopic display module 27, a front viewer image capturing sensor module 21 (or an eye-tracking camera) used for direct execution of eye-tracking function to obtain focal point coordinates (x1, y1) of viewers, and a rear viewer image capturing sensor module 23 (or a stereoscopic depth camera) used for capturing stereoscopic images and/or capturing 2D images along with a depth diagram of an image. The system also comprises a plurality of image processing modules 25. The image processing modules 25 are used for forming, gaining and outputting to display three-dimensional (3D) stereoscopic images. Three-dimensional (3D) stereoscopic images are formed by using 2D images and depth diagram information corresponding to the 2D images. Gain of three-dimensional (3D) stereoscopic images is processed by executing a number of image analyses and filtering algorithm on three-dimensional (3D) stereoscopic images, and by correcting three-dimensional (3D) stereoscopic images in use of image data and depth diagram data. Another image processing module 25 uses a method of extrapolating to extrapolate the focal point coordinates (x1, y1) of viewers, and therefore executes auto-focusing and translates the focal point coordinates (x1, y1) of viewers into display coordinates (x2, y2) (or named as second coordinates) with respect to the display module 27. Then, segments of the image are confirmed in order to reflect the display coordinates (x2, y2), and used to form a suitable stereoscopic gained image in order to confirm the stereoscopic image being displayed is located on focuses. The last image processing module 25 functions for inputting and gaining stereoscopic images, and then for executing RGB sub-pixel algorithm to output stereoscopic images to the display module 27.

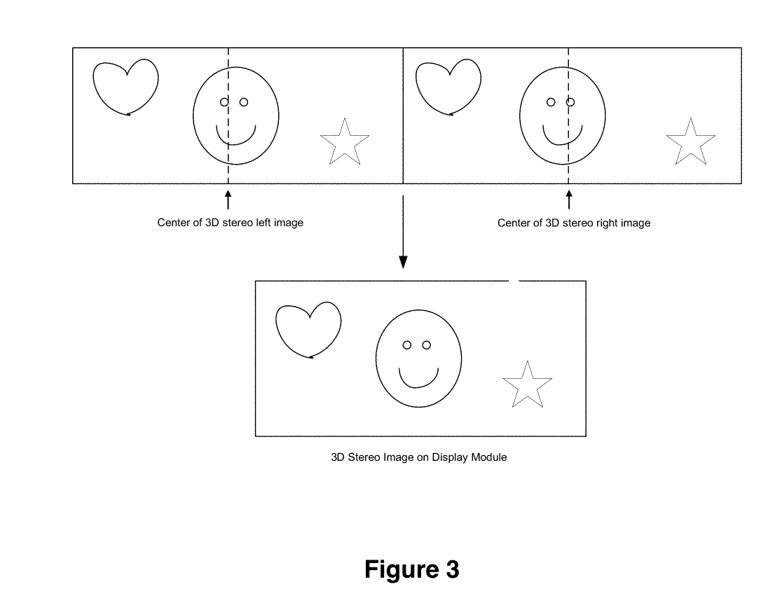

Based on the above, further referring to FIG. 3, FIG. 3 shows a schematic diagram of a three-dimensional (3D) stereoscopic image obtained from the display module 27 when the rear viewer image capturing sensor module 23 is a stereo camera apparatus. In FIG. 3, the stereoscopic image can comprise three images (such as a heart shape, a star and a smiley face). A center of the stereoscopic image is expressed by a broken line for illustrating the stereoscopic image of FIG. 3 is an image with depths and the stereoscopic image comprises a left-side image and a right-side image. However, the image with depths is generated based on images retrieved from different focusing positions of viewers when a same image, such as the heart shape, the star or the smiley face, is viewed. Finally, the image processing module 25 executes the three-dimensional (3D) sub-pixel mapping step. The sub-pixel mapping step is executed to merge the left-side and right-side images into RGB images which can be output to the display module 27 so that the viewers can see a precisely focused three-dimensional (3D) stereoscopic image.

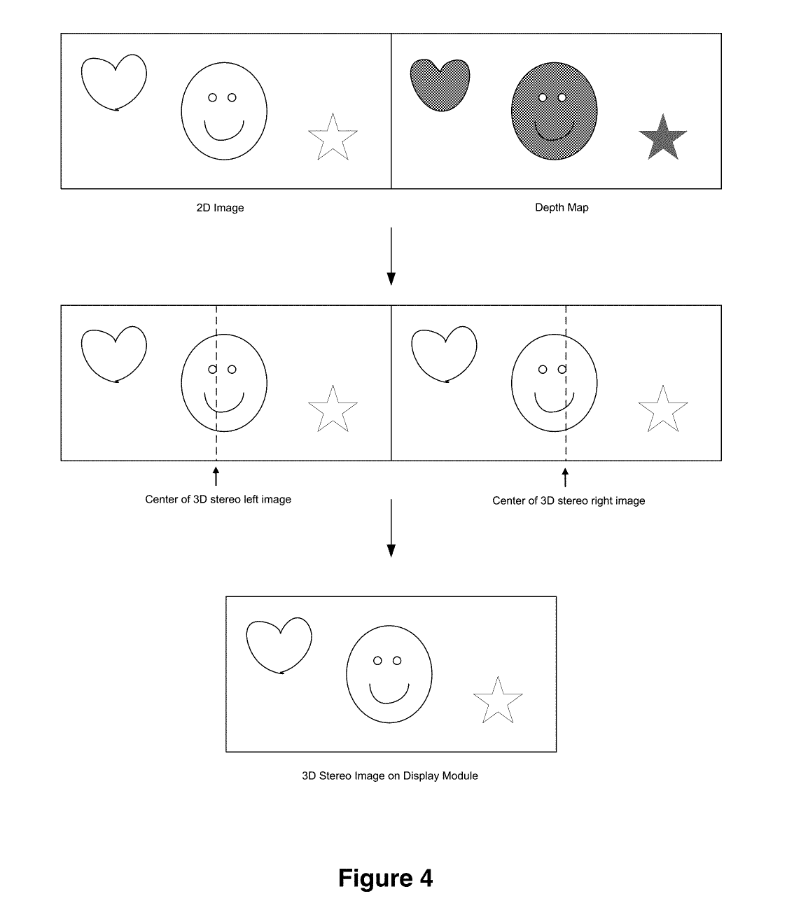

Referring to FIG. 4, FIG. 4 shows a schematic diagram of images having the corresponding depth diagram and obtained from the display module 27. The corresponding depth diagram can be obtained by a number of methods, including but not being limited to, use of time-of-flight sensors, depth map calculating integrated circuits and soft image processing algorithms to construct the depth diagram from two-dimensional (2D) or three-dimensional (3D) stereoscopic images. A general depth diagram comprises a set of depth values assigned to each pixel of the corresponding images. In the present invention, the image processing module 25 processes the depth values and uses image processing algorithms to define segments, or define regions of the depth values based on a scope of the depth values. Auto-focusing image processing of the present invention is executed to determine the segments of images by using the depth diagram and to define the segments by the corresponding depth diagram. The display coordinates (x2, y2), and focused and corrected three-dimensional (3D) stereoscopic images which are established based on the segments of the images or parts of the images are reflected and expressed to further reflect and express images within the segments.

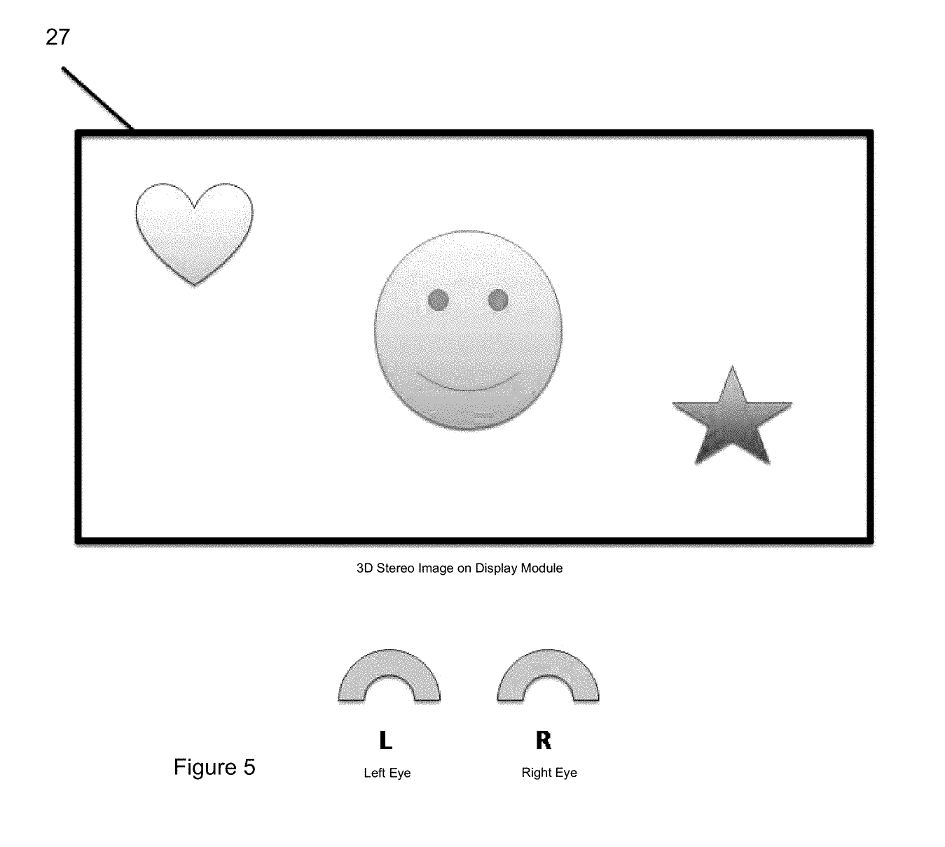

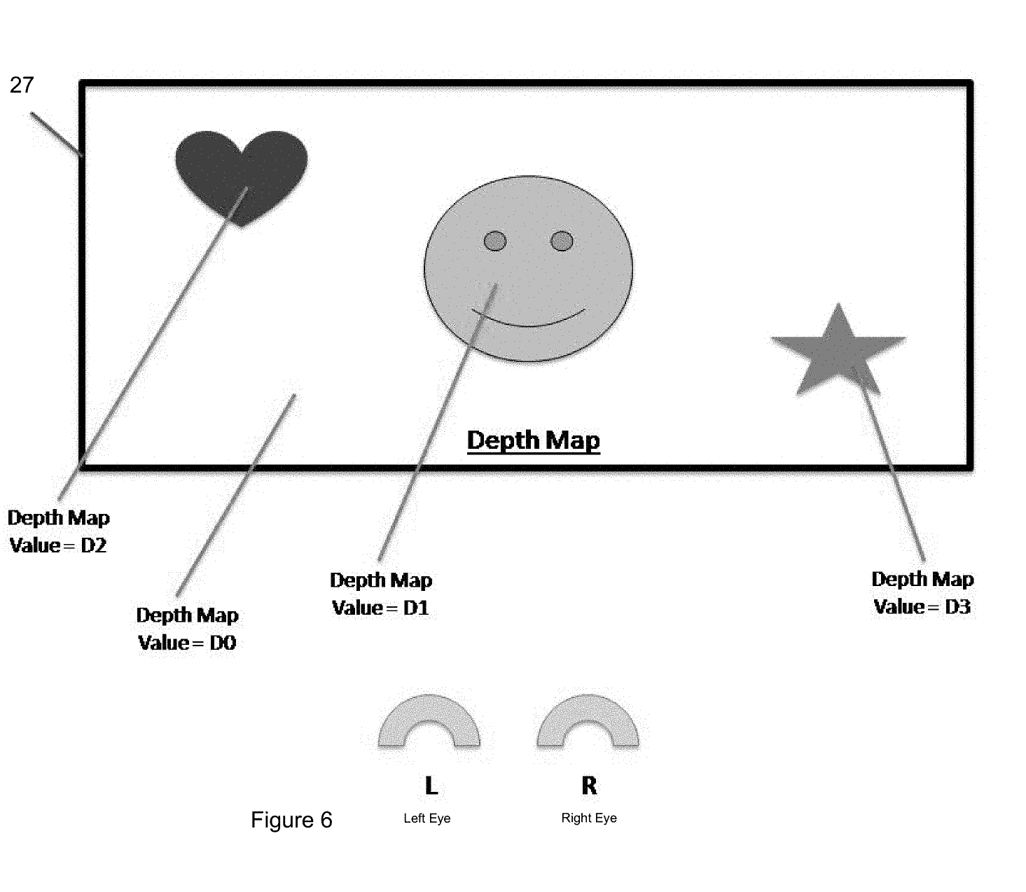

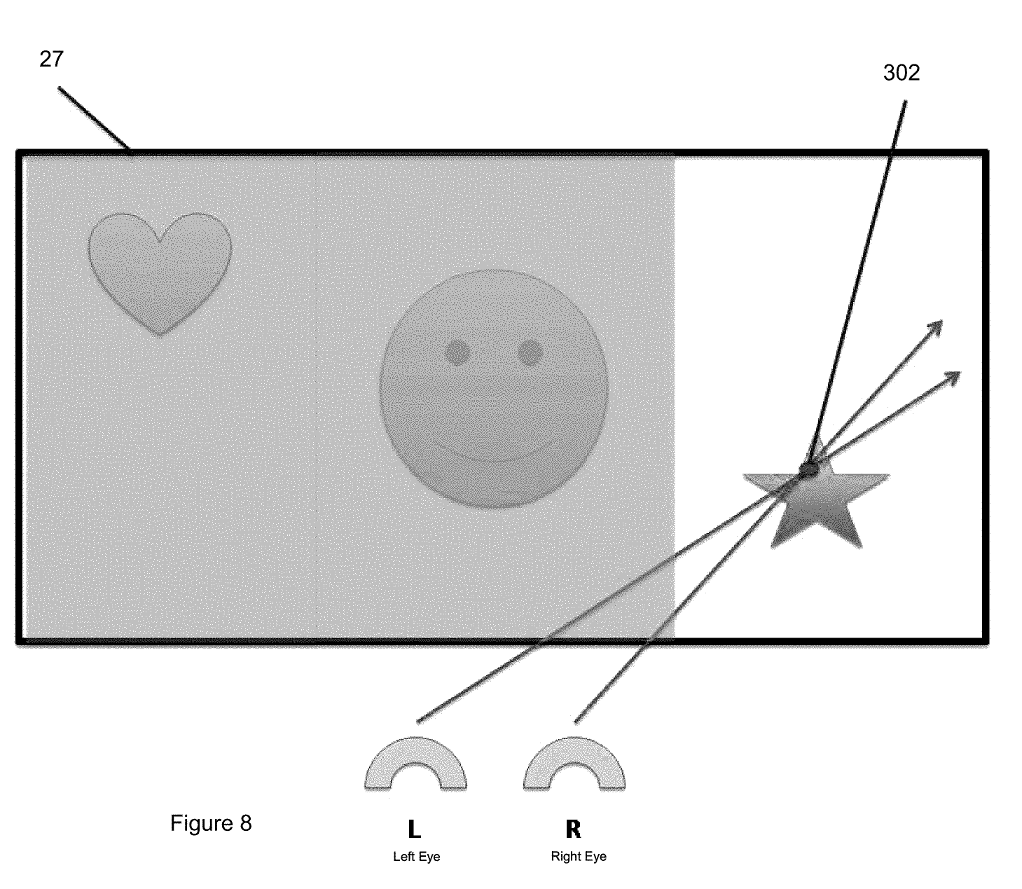

FIGS. 5 to 9 show schematic diagrams of execution of steps of the three-dimensional (3D) auto-focusing display method in according with the present invention. When the display module 27 is provided for the viewers (or users) to watch three-dimensional (3D) stereoscopic images, two visual images including depths and parallax disparity in left and right eyes of the viewers are simultaneously generated due to perception of three-dimensional (3D) stereoscopic images by the viewers. However, a convergent focal point 30 is firstly generated when the left and right eyes are used to watch three-dimensional (3D) stereoscopic images. Under conditions that camera systems are set to confront the viewers and to track the viewer's eyes, and that image sensing and software image processing are combined, focuses of the viewer's eyes are therefore obtained. In other words, when the viewers watch the star in FIG. 8, parallax disparity is generated in the eyes of the viewers and another convergent focal point 302 is formed on the star to be watched. Since the star is a three-dimensional (3D) stereoscopic image, the parallax disparity is generated when watching the three-dimensional (3D) stereoscopic image (star) because of different locations on the display and different distances and depths (or referring to distances away from a screen of the display) of the viewer's eyeballs.

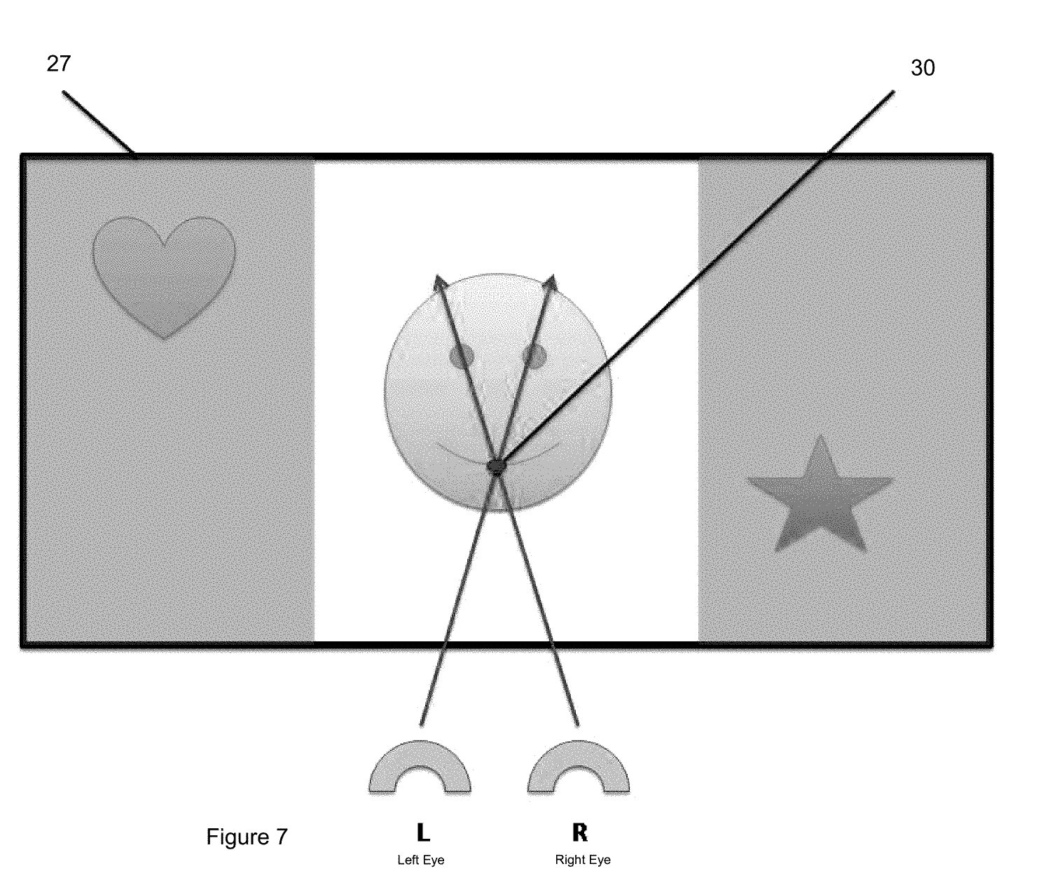

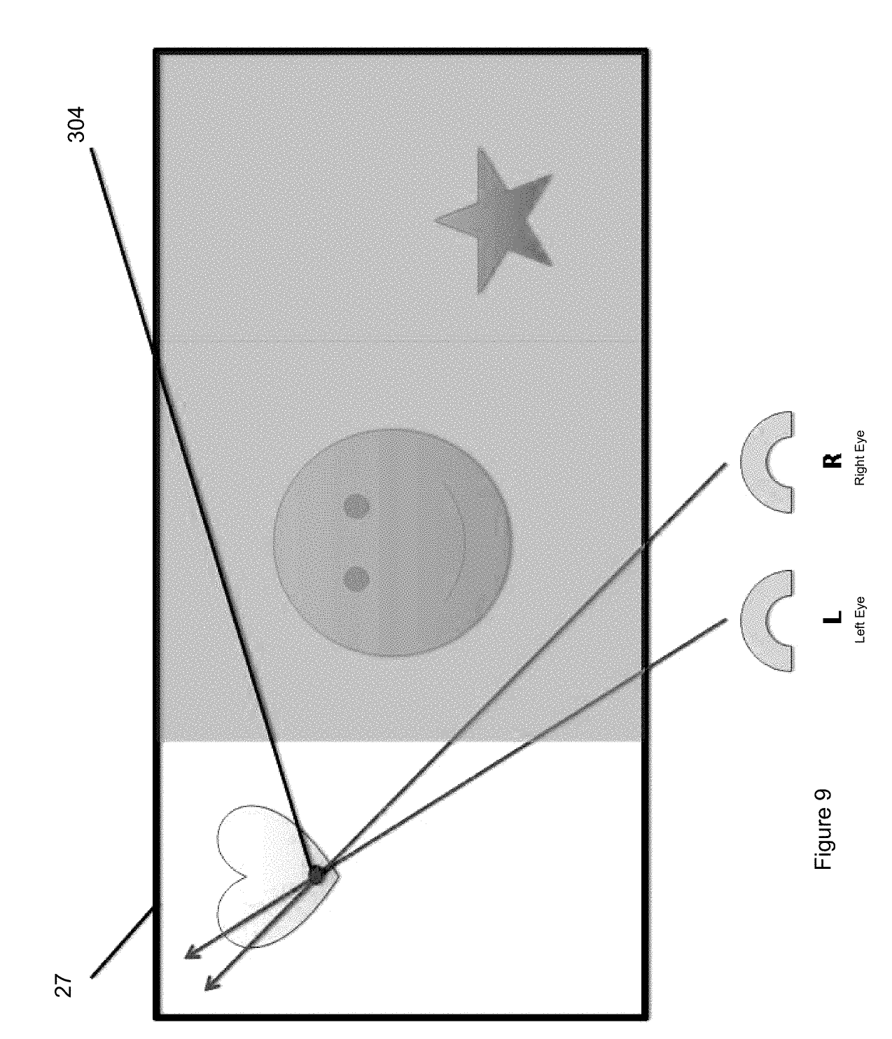

Further referring to FIG. 7, the rear viewer image capturing sensor module 23 of camera systems is used to obtain depth map information of watched images viewed along a depth diagram of images. In FIG. 9, another convergent focal point 304 is formed on a heart shape image when the viewers watch it. Depth map information of the heart shape image at a left side of the whole picture is obtained by using the rear viewer image capturing sensor module 23 via the convergent focal point 304 when the viewers watch the heart shape image. Furthermore, information of a depth diagram of the heart shape image is obtained by using a combined structure of image sensors and software image processing. Finally, three-dimensional (3D) stereoscopic images are obtained based on the above to recalculate a distance between the viewer's eyeballs and the display, and to combine each image (or also called as “pixel”) having a depth different from others which is viewed by the viewer's eyeballs according to the eye-tracking system.

Although only the preferred embodiments of the present invention are described as above, the practicing scope of the present invention is not limited to the disclosed embodiments. It is understood that any simple equivalent changes or adjustments to the present invention based on the following claims of the present invention and the content of the above invention description may be still covered within the claimed scope of the following claims of the present invention.

What is claimed is:

1. A three-dimensional (3D) auto-focusing display method, comprising:
providing an image;
executing an eye-tracking step on the image to obtain focal point coordinates (x1, y1) of viewers of the image;
mapping the focal point coordinates (x1, y1) of viewers to a coordinate location of a display to obtain display coordinates (x2, y2) for defining the coordinate location of the display corresponding to a depth diagram of the image;
determining a region where the image is located by using the display coordinates (x2, y2) as an input parameter and by use of the depth diagram of the image;
determining whether the image is three-dimensional (3D) stereoscopic images according to the region where the image is located, and executing a depth map step to revise the 3D image based on the image and a plurality of depth data of the region to reflect the display coordinates (x2, y2) as a focused image; and
outputting the revised focused image to the display to display 3D stereoscopic images on the display.

2. The three-dimensional (3D) auto-focusing display method as claimed in claim 1, wherein the image is one of a landscape, portrait or physical substance goods.

3. The three-dimensional (3D) auto-focusing display method as claimed in claim 1, wherein the depth diagram of the image is a combination of a plurality of segments of different regions.

4. The three-dimensional (3D) auto-focusing display method as claimed in claim 3, wherein each segment is defined as a set of pixels of the image, and the image has a same depth value or in a range of the same depth value.

5. A three-dimensional (3D) auto-focusing display system, comprising:
a front viewer image capturing sensor module used for performing an eye-tracking function on an image to obtain focal point coordinates (x1, y1) of viewers of the image;
a rear viewer image capturing sensor module used for capturing the image;
an image processing module used for processing the image to obtain display coordinates (x2, y2) corresponding to the image and to display the image as a 3D stereoscopic image; and
a display module used for displaying the 3D stereoscopic image.

6. The three-dimensional (3D) auto-focusing display system as claimed in claim 5, wherein the front viewer image capturing sensor module is a camera apparatus with sensors or a web camera apparatus with pupil detection function.

7. The three-dimensional (3D) auto-focusing display system as claimed in claim 5, wherein the rear viewer image capturing sensor module is one of a time-of-flight camera apparatus, a stereoscopic camera apparatus, and a web camera apparatus with image depth generating function.

8. The three-dimensional (3D) auto-focusing display system as claimed in claim 5, wherein the image processing module further uses a two-dimensional (2D) image and information of a depth diagram corresponding to the 2D image to form the 3D stereoscopic images.

9. The three-dimensional (3D) auto-focusing display system as claimed in claim 5, wherein the image processing module further executes a number of image analyses and filtering algorithm on the 3D stereoscopic images, and corrects the 3D stereoscopic images in use of image data and depth diagram data.

10. The three-dimensional (3D) auto-focusing display system as claimed in claim 5, wherein the image processing module further uses a method of extrapolating to extrapolate the focal point coordinates (x1, y1) of viewers, and therefore executes auto-focusing and translates the focal point coordinates (x1, y1) of viewers into the display coordinates (x2, y2) with respect to the display module, and confirms segments of the image in order to reflect the display coordinates (x2, y2), and to form a suitable stereoscopic gained image and confirm the 3D stereoscopic image being displayed is located on a focus of the display module.
